(19) United States
(12) Patent Application Publication
(10) Pub. No.: US 2015/0339083 A1
(43) Pub. Date: Nov. 26, 2015

(54) US SYSTEM AND METHOD FOR TRANSMITTING AND DISPLAYING PRINTABLE ELECTRONIC FILES THROUGH A USER INTERFACE

(71) Applicant: APPLIED RESEARCH WORKS, INC., PALO ALTO, CA (US)

(72) Inventors: SHAIBAL ROY, PALO ALTO, CA (US); AMITAVA MAULIK, KOLKATA (IN); SIRSENDU MOHANTA, KOLKATA (IN); VITERBO TABAQUIN, HONOLULU, HI (US)

(73) Assignee: APPLIED RESEARCH WORKS INC., PALO ALTO, CA (US)

(21) Appl. No.: 14/222,706

(22) Filed: Mar. 24, 2014

Related U.S. Application Data
(63) Continuation-in-part of application No. 14/221,308, filed on Mar. 21, 2014, now abandoned.

(51) Int. Cl. G06F 3/12

(52) U.S. Cl. CPC G06F 3/1209; G06F 3/1245; G06F 3/1253

(57) ABSTRACT

Disclosed is a system and method for operating a virtual printer through a user interface. The disclosed method enables a user to use a user interface to create images of viewable files and store the images on a central repository or share the images with other users, wherein the user interface displays a series of dialogue boxes. The user interface displays virtually printed images to users as thumbnail images that users may then click to view the full size image.

### PRIORITY CLAIM

This application is a continuation-in-part of, and claims the benefit of, U.S. application Ser. No. 14/221,308 filed on Mar. 21, 2014. The aforementioned application is hereby incorporated by reference.

### BACKGROUND

Many electronic files can be printed. When electronic files are viewed in web browsers, for example, a print function is often available to the user to print what is viewed on a local or network printer. Increasingly, there is a need to transmit and display such files in electronic media, rather than on paper. Using an already existing print function to transmit, display, and store existing electronic files has many advantages. Such advantages include an elimination of the need to print and use paper and ink or toner, and a convenient and easy means of transmitting and storing electronic files.

When transmitting secure information, a need often arises to maintain the security of printable files. For security reasons, it may be desirable to restrict the ability of certain users to save files onto a local device, while still allowing the same users to view or transmit a viewable file. In such instances, a method for storing a printable file on a central repository can ensure a file is viewable, but will not be stored on a local device.

### BRIEF SUMMARY

Disclosed is a system and method that enables users to send any printable electronic file to a repository without saving the file onto a local device. Uses lacking permissions to store an electronic file on their local device are able to securely transmit an electronic file to another user. In certain embodiments, the system will convert viewable electronic files into an alternative language, such as .PS (PostScript) format, or another alternative language. In certain embodiments, the resulting .PS file will be converted by the system into .pdf (portable document format), or another alternative viewable format.

### BRIEF DESCRIPTION OF THE DRAWINGS

FIG. 1 illustrates an embodiment of a computer based system wherein data is transmitted across a plurality of networks and devices.

FIG. 2 illustrates an embodiment of a workflow through which information is processed and displayed to a user.

FIG. 3 illustrates an embodiment of a method for receiving and processing a print request on a virtual printer.

FIG. 4 illustrates an embodiment of a method for processing viewable files and displaying the viewable files to a user.

FIG. 5 illustrates an embodiment of a user interface through which a user can request a viewable file be displayed or transmitted by using a virtual printer.

FIG. 6 illustrates an embodiment of a user interface through which a user supplies credentials to utilize a virtual printer.

FIG. 7 illustrates an embodiment of a user interface through which a user is able to provide additional information regarding a viewable file the user is about to upload.

FIG. 8 illustrates an embodiment of a user interface informing a user that a file has been successfully uploaded.

FIG. 9 illustrates an embodiment of a user interface wherein files have been uploaded through a virtual printer.

FIG. 10 illustrates an embodiment of a user interface wherein thumbnails of files uploaded though a virtual printer are displayed to a user.

### DETAILED DESCRIPTION

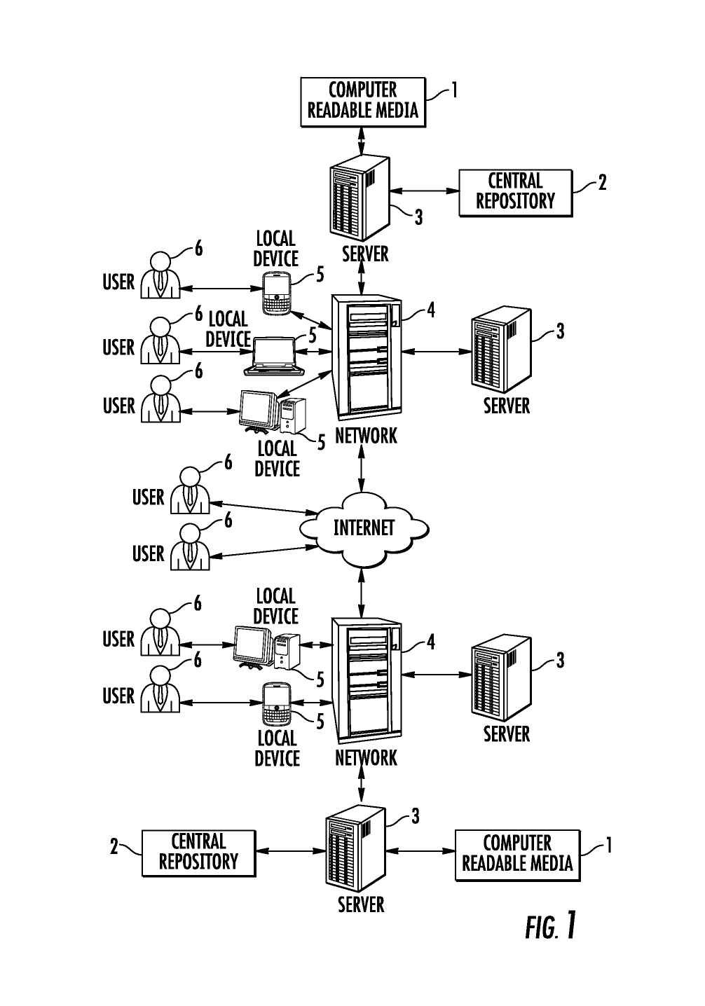

Disclosed is a system and method for using a virtual printer to transmit and display data. FIG. 1 illustrates a representative embodiment of the disclosed system. In certain embodiments, computer executable instructions for carrying out the various methods disclosed are stored on computer readable media 1. The computer readable media may be coupled to one or more servers 3. One or more central repositories 2 store data. The one or more central repositories are coupled to a server 3 in certain embodiments, but may also be coupled to one or more local devise 5 in other embodiments. One or more users 6 access the system by using a local device 5. A local device 6 may be any device capable of interfacing with a computer network. By way of example, and not limitation, a local device 6 may be a smart phone, desktop computer, laptop computer, tablet device, pager, or other electronic device. In alternative embodiments, users may access the system through local area networks, telephonic devices, radio frequencies, computers, or other electronic devices. Certain embodiments comprise one or networks 4, which may be optionally coupled to the Internet. The system comprises one or more servers 3, each server 3 coupled to one or more networks 4. In certain embodiments, one or more servers 3 are coupled to the Internet.

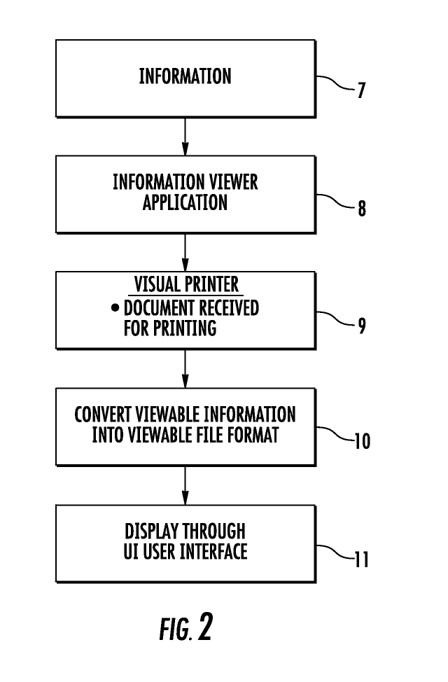

FIG. 2 illustrates an embodiment of a workflow through which information 7 is processed. Information 7 is any electronic file that is viewable to a user 6 through an information viewer application 8. An information viewer application 8 is any computer program through which viewable information is displayed. By way of example, and not limitation, information viewer applications 8 include web browsers, reader applications, word processors, spreadsheet applications, databases, and photo viewers. A visual printer 9, also referred to as a virtual printer, is a software application that has a user interface similar to an actual printer, but rather than printing a paper copy of the information 7, a virtual image is produced, and stored on the central repository 2 or transmitted over the system to be viewed by another user 6. When the system receives a request to begin virtual printing, the information 7 is converted into a viewable file format. In certain embodiments, the viewable file format is Portable Document Format (.pdf). In alternative embodiments, other viewable file formats may be used. Any file format that enables a user to view information 7 may be a viewable file format. In alternative embodiments, the information 7 is converted to an alternative computer language, such as PostScript (PS), and stored on the central repository before being converted to a viewable file format images. After the viewable information is converted into a viewable file format 10, the viewable file format is displayed to one or more users through a user interface 11.

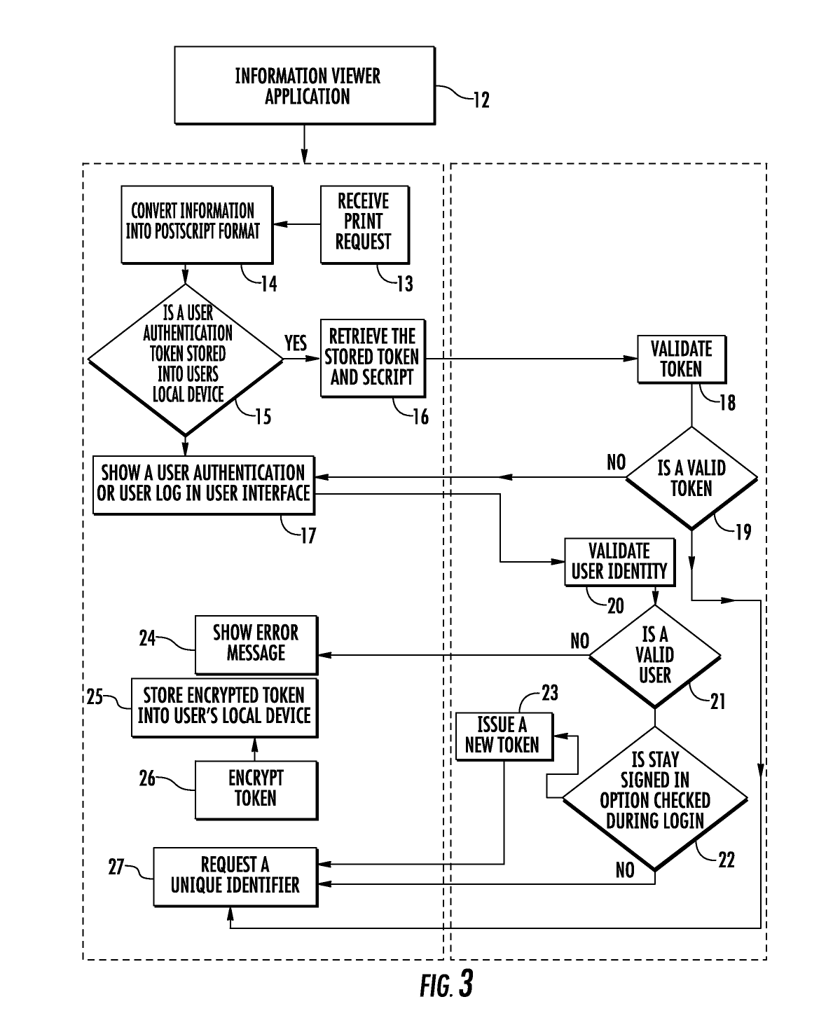

FIG. 3 illustrates the method by which a virtual print request is processed. A user accesses information through an information viewer application 12. When a user initiates a print request 13, information is converted into an alternative computer language. In the embodiment illustrated, the information is converted to PostScript (PS) format 14. After completing the conversion to an alternative computer language, the system determines if a user authentication token is stored on the user's local device 5. If a user authentication token is stored on the user's local device 5, the token is retrieved 16, and validated 18. In certain embodiments, validation includes the steps of decrypting the token and sending the decrypted token to a web server through HTTPS headers. If the token is valid, the system will request a unique identifier 27 from the user. If no token is found on the user's local device 5, or if a token is not valid, the user 6 will be shown a user authentication or user log in on a user interface 17. The identity of the user will then be validated 20. The system will then determine if the user is a valid user 21. IF the user is a valid user, the system will determine if the user is presently singed into the system 22. If the user is signed into the system, the system will request a unique identifier from the user. If the user is not singed into the system, a new token will be issued 23 and a unique identifier will be requested 27. If the user is not a valid user, an error message will be displayed to the user 24. After unique identifiers are requested 27, tokens are encrypted 26 and stored on the user's local device 25.

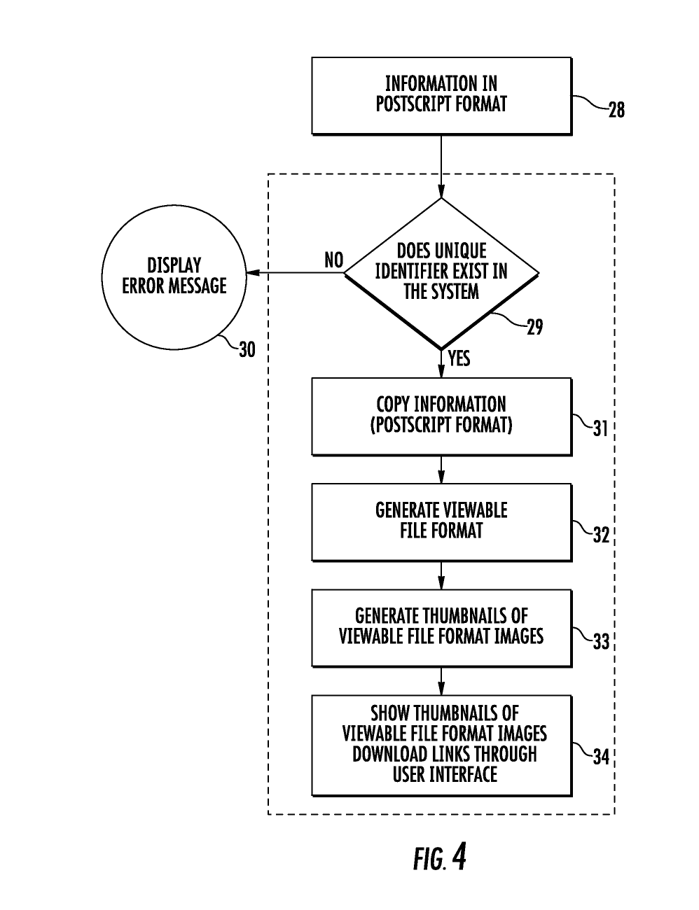

FIG. 4 illustrates an embodiment of the workflow after information has been converted to an alternative language. In the embodiment illustrated by FIG. 4, the information is in PostScript (PS) format 28. The system first determines if a unique identifier associated with a user exists in the system 29. If the unique identifier does not already exist in the central repository, an error message is displayed to the user 30. If a unique identifier does exist in the central repository, the information in the alternative language is copied 31. A viewable file format is then generated 32. In some embodiments the viewable file format will be portable document format (.pdf). Thumbnail images of the viewable file formats are then generated 33. Thumbnail images of the viewable file format images are then displayed to users through a user interface 34. Users 6 may then view the variable file images by clicking on the thumbnail images.

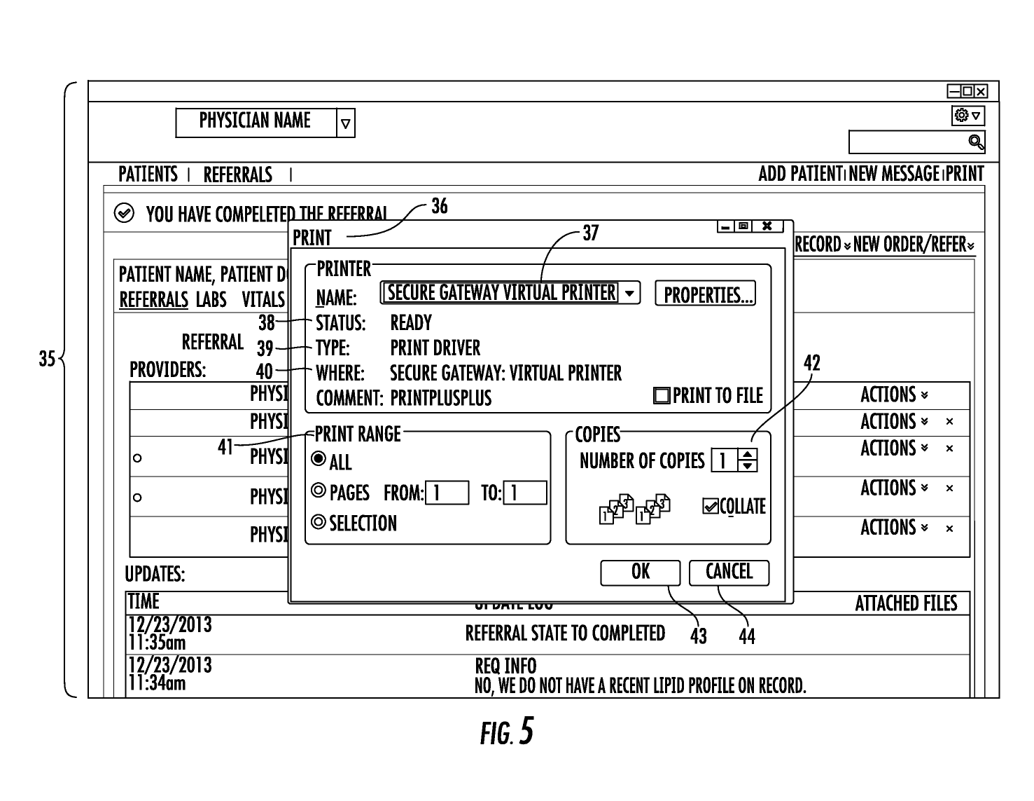

FIG. 5 is an illustration of an embodiment of a user interface 35 through which users 6 interface with the system. The embodiment illustrated in FIGS. 5-10 are user interfaces for applications in the healthcare setting, but the present invention is not limited to healthcare, and those skilled in the art will appreciate the applicability of the present invention across numerous disciplines, industries, and fields of use. When a user 6 decides to print a file to the virtual printer, a user 6 will use a print command on information viewer application. FIGS. 5-10 illustrate a web browser; however, other programs can be used as an information viewer application. When a print command is selected by the user 6, a print dialogue box 36 appears on the user interface 35. In order to print to the virtual printer, the user 6 selects the virtual printer 37 in the print dialogue box 36. Some embodiments of the print dialogue box 36 will indicate a status 38, type 39, and location 40 of the file to be sent to the virtual printer. Additionally, in certain embodiments, users 6 may select a print range 41, and number of copies 42. The file is sent to the virtual printer when the user 6 clicks OK 43 or the process is cancelled when the user 6 clicks cancel 44.

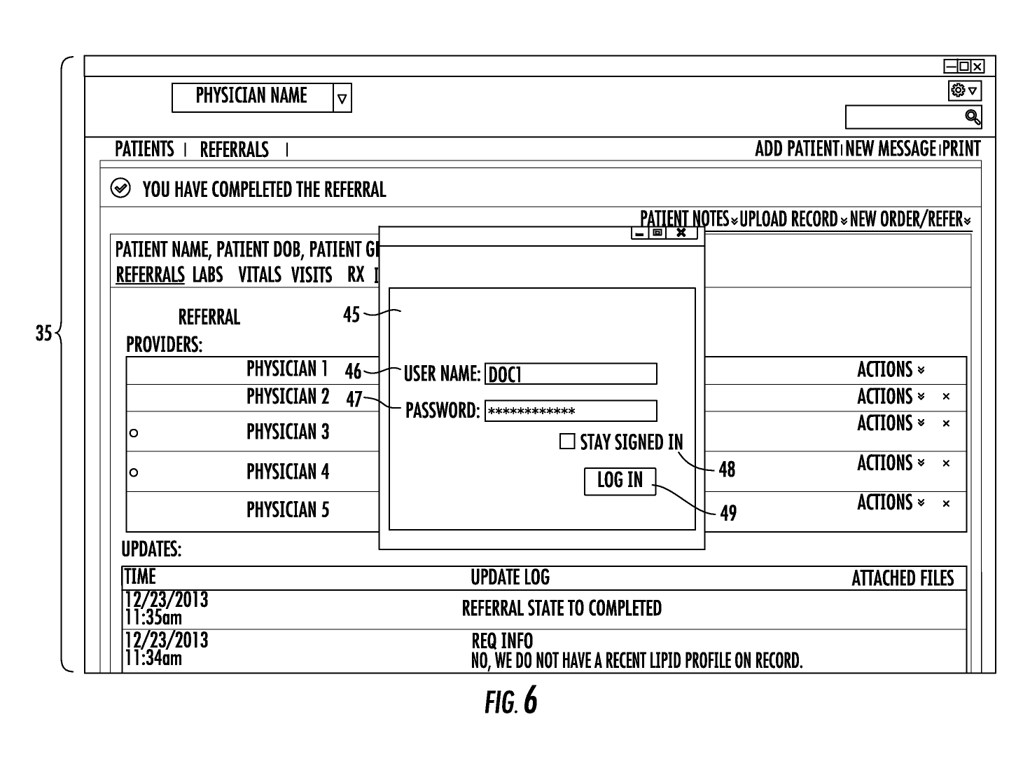

FIG. 6 illustrates an embodiment of the user interface 35, wherein a credential dialogue box 45 is displayed, allowing a user 6 to enter a user name 46 and password 47. In certain embodiments, a user may elect to stay signed into the system 48. A user logs into the system by clicking on a Log In button 49 in the credential dialogue box 45.

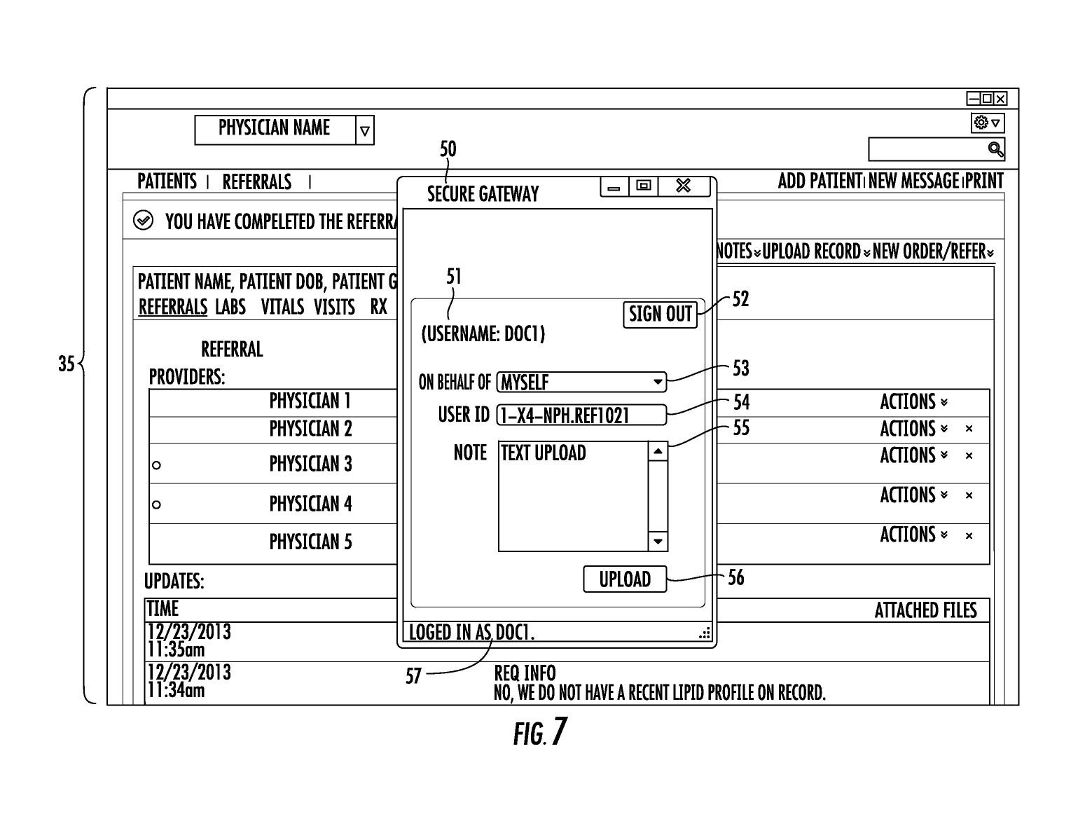

FIG. 7 illustrates an embodiment of the user interface 35 on which a secure gateway dialogue box 50 appears. The secure gateway dialogue box includes the user name associated with the user 51, a button a user 6 can click to sign out 52, a field to select who the user is acting on behalf of 53, a user ID 54, space for entry of text for notes 55, a button a user 6 can click to upload a file to the central repository 2, and an indication of what username is currently logged onto the system 57. In certain embodiments the user ID 54 can also be substituted with the unique identifier discussed above.

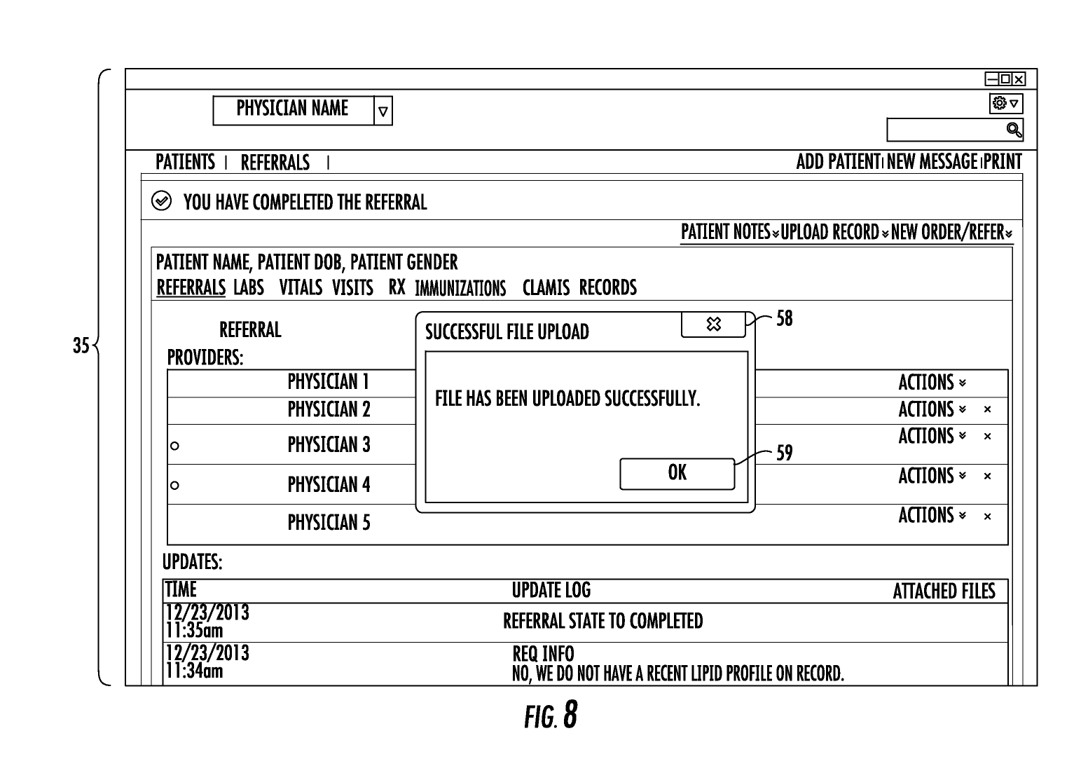

FIG. 8 illustrates an embodiment of the user interface 35 displaying a dialogue box 58 indicating the file has been successfully uploaded to the central repository 2. A button 59 allows the user 6 to acknowledge the upload was successful.

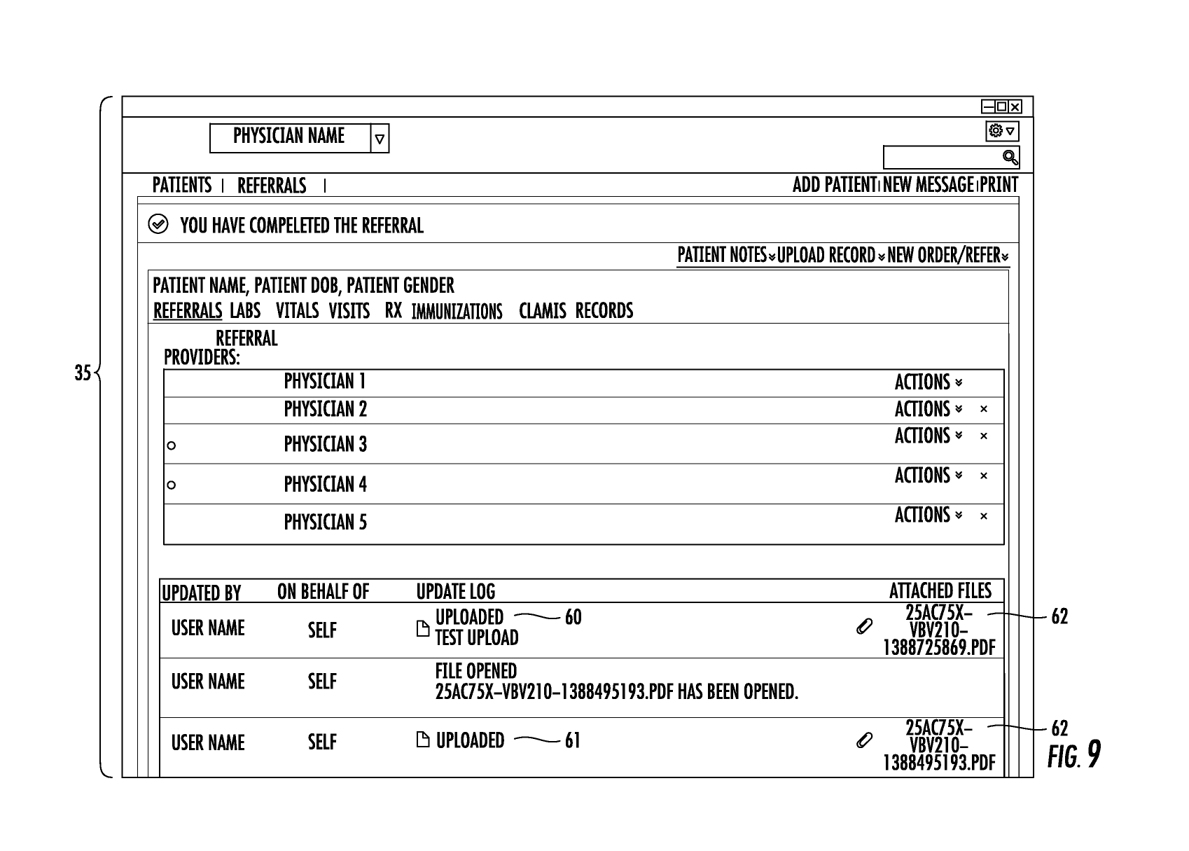

FIG. 9 illustrates an embodiment of the user interface 35 wherein uploaded files are displayed to users 6. The uploaded files are shown to be uploaded 60 and the files can be viewed by users 6 by clicking on the attached files 62. The files may be displayed to the user who requested they be uploaded via the virtual printer or they may be displayed to a different user. Users may direct a file to be “printed to” another user's account or user interface.

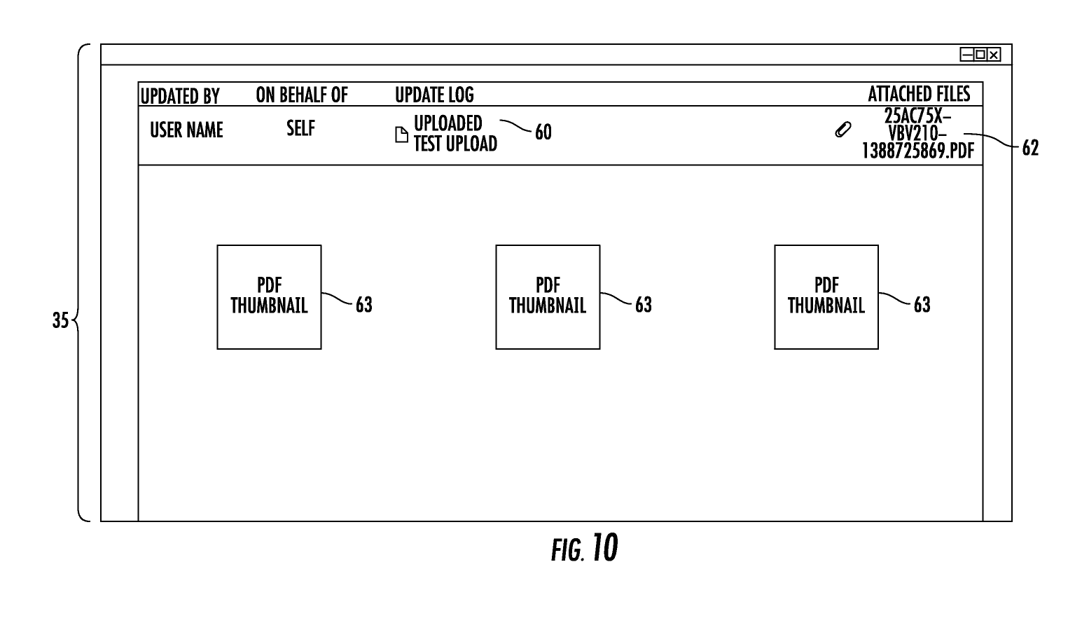

FIG. 10 illustrates an embodiment of the user interface 35 wherein files are displayed as uploaded 60 and are attached 62 to the user interface, but also displayed as thumbnail images 63. Users may view full size images of the files by clicking on the thumbnail images 63.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. In particular, those skilled in the art will appreciate that the present invention has utility in multiple settings and industries. It is intended, therefore, that the invention be defined by the scope of the claims that follow and that such claims be interpreted as broadly as reasonable.

What is claimed is:

1. (canceled)

2. (canceled)

3. A method for operating a virtual printer comprising the steps of:
displaying a user interface to a user in an information viewer application, said user interface displaying a print dialogue box, the print dialogue box displaying a printer name selected by the user and a print rage selected by the user;
generating a print request from the user when the user submits a print command through the print dialogue box;
converting information into an alternative computer language;
generating a viewable file format image;
storing the viewable file format on a central repository;
displaying a credential dialogue box on the user interface, said credential dialogue box having fields for the user to enter a username and a password;
obtaining a username and a password from the user;
displaying a secure gateway dialogue box on the user interface, said secure gateway dialogue box having fields for a user to indicate the party the user is acting on behalf of;
obtaining an input of the party the user is acting on behalf of;
receiving a command to upload the viewable file format image to central repository from the user; and
displaying a dialogue box indicating the viewable file format image has been successfully uploaded, said dialogue box displayed on the user interface.

4. The method of operating a virtual printer of claim 3 further comprising the steps of:
displaying thumbnail images of uploaded viewable file format images on the user interface; and
displaying the uploaded viewable file format images on the user interface when a user clicks on the thumbnail images of unloaded viewable file format images.

5. (canceled)

6. (canceled)

7. A non-transitory computer-readable medium having computer-executable instructions for operating a virtual printer comprising the steps of:
displaying a user interface to a user in an information viewer application, said user interface displaying a print dialogue box, the print dialogue box displaying a printer name selected by the user and a print rage selected by the user;
generating a print request from the user when the user submits a print command through the print dialogue box;
converting information into an alternative computer language;
generating a viewable file format image;
storing the viewable file format on a central repository;
displaying a credential dialogue box on the user interface, said credential dialogue box having fields for the user to enter a username and a password;
obtaining a username and a password from the user;
displaying a secure gateway dialogue box on the user interface, said secure gateway dialogue box having fields for a user to indicate the party the user is acting on behalf of;
obtaining an input of the party the user is acting on behalf of;
receiving a command to upload the viewable file format image to central repository from the user; and
displaying a dialogue box indicating the viewable file format image has been successfully uploaded, said dialogue box displayed on the user interface.

8. The non-transitory computer-readable medium having computer-executable instructions for operating a virtual printer of claim 7 further comprising the steps of:
displaying thumbnail images of uploaded viewable file format images on the user interface; and
displaying the uploaded viewable file format images on the user interface when a user clicks on the thumbnail images of unloaded viewable file format images.
